(19) United States
(12) Patent Application Publication
(10) Pub. No.: US 2009/0099723 A1
(43) Pub. Date: Apr. 16, 2009

(54) Method for optimizing vehicles and engines used for driving such vehicles

(76) Inventor: Peter Schoggl, Hitzendorf (AT)

Correspondence Address: DYKEMA GOSSETT PLLC, FRANKLIN SQUARE, THIRD FLOOR WEST, 1300 I STREET, NW, WASHINGTON, DC, 20005, US

(21) Appl. No.: 12/230,776

(22) Filed: Sep. 4, 2008

Related U.S. Application Data
(63) Continuation of application No. 10/555,995, filed on Dec. 14, 2005, now abandoned.

(30) Foreign Application Priority Data
May 13, 2003 (AT) A 731/2003

(51) Int. Cl. G01M 17/00

(52) U.S. Cl. 701/29

(57) ABSTRACT

The invention relates to methods for optimizing vehicles and engines that are used for driving such vehicles, comprising the following steps: measurements are taken during real operation of the vehicle (10) on the road or on a roller-type test stand or the engine (21) on an engine test stand (19); a simulation model representing the vehicle (10) or the engine (19) is parameterized so as to be able to arithmetically determine a prediction about the measured values obtained by means of said measurements; the vehicle (10) is simulated by using the simulation model (11), at least one drivability index (DR) being additionally calculated which results from several measured values based on an empirically determined function and indicates the drivability of a vehicle (10) in a specific driving mode; the settings of the vehicle (10) are optimized during said simulation, at least one drivability index (DR) being input into the target function or the fringe conditions of the optimization process.

The invention relates to a method for optimizing vehicles and engines that are used for driving such vehicles. It is understood that the present invention also comprises subsystems such as the drive train or electronic engine control units.

The optimization of settings in modern motor vehicles is a difficult field because the number of degrees of freedom is exceptionally high. This relates both to the tuning of racing vehicles, which is primarily used to achieve the maximum competitiveness (i.e. the best lap times at a driveable tuning), as well as the settings of series-produced vehicles with respect to convenience, drivability, fuel consumption and exhaust gas emissions. The difficulties in connection with tuning arise from the fact that a plurality of setting parameters can be varied and that the change of the setting parameters will usually cause in a complex way and in several aspects a change in the behavior of the motor vehicle. The optimization of the setting is therefore usually performed by qualified technicians in practice, who as a result of the extensive experience are in the position to assess the consequences of certain changes in the settings and to perform the desired optimization. It is still necessary in the course of such optimizations however to undertake numerous driving tests in the course of an iterative process in order to verify the achieved intermediate results and to optionally correct the same. Feedback given by the driver is usually used in order to make decisions on the tuning measures that will be undertaken.

The described procedure requires test and trial drives and a subjective evaluation by race and test drivers. These test drives are often not possible for technical reasons or for reasons of predetermined rules.

It is known in order to reduce test drives with real vehicles or examinations on test stands to use simulation models which can assume optimization tasks at least in part. Examples for such methods are disclosed in EP 0 877 309 B, WO 00/32465, U.S. Pat. No. 6,434,454 B or EP 0 474 944 B. Such simulation models can only illustrate partial aspects of the tuning to be optimized such as the optimal calculation of a virtual sensor as a data source for the electronic system of an engine, as is described in the aforementioned EP 0877 309 B.

It is the object of the present invention to provide a method which is capable of illustrating not only partial aspects of the vehicle tuning, but of performing in the simplest possible way an overall optimization. The use of the real vehicle shall be minimized to the highest possible extent and the evaluation by experienced test engineers shall be avoided substantially in order to reduce costs on the one hand and avoiding subjective components to the highest possible extent.

These objects are achieved by a method comprising the following steps:
Performance of measurements during real operation of the vehicle on the road or on a roller-type test stand or the engine on an engine test stand;
a simulation model representative of the vehicle or engine is parameterized so as to be able to arithmetically make a prediction on the measured values obtained by means of said measurements;
the vehicle is simulated by using the simulation model, with at least one drivability index being additionally calculated which is obtained from several measured values based on an empirically determined function and indicates the drivability of a vehicle in a specific driving mode;
the settings of the vehicle are optimized during said simulation, with at least one drivability index being input into the target function or boundary conditions.

The relevant aspect in the present invention is the use of drivability indexes or so-called drivability variables. Such drivability indexes are values which are obtained as a function from several measurable variables and which represent the drivability of the vehicle in certain key situations which are also designated as trigger conditions. The definition of these functions occurs empirically, such that evaluations given by a plurality of test drivers are compared with the calculated functional values, with the functions being changed and adapted until an optimal conformance between the functional values and the actually present evaluations is achieved. The present invention is based on the realization that an optimization of the drivability preferably does not occur on the basis of individual measured values, but also includes drivability indexes. Even though it seems obvious to perform an optimization towards the achievable lap time for a racing car for example because this is the obvious measure for the quality of the racing car, it has still been seen that results that are more practical and finally more successful strategies can be achieved to the extent that drivability indexes are included in the optimization. This means that an optimization problem is present which comprises a target function (e.g. the lap time) and a plurality of boundary conditions. The boundary conditions can be limitations imposed by rules such as the minimum vehicle weight or limitations concerning the vehicle dimensions, aerodynamics or the like. They can be of a technical and physical nature such as resilience limits of the employed material or maximum permitted wear and tear to the tires, fuel consumption or minimum values for different drivability indexes which are required. The drivability of the engine in partial load or in case of engagement of traction control will have to exceed a certain limit value. This value can be different in racing cars for races or training. Moreover, the handling behavior of the vehicle in different areas of the track (acceleration, braking, curve entrance, curve center, curve exit and the like) can be evaluated objectively and be predetermined as a boundary condition. As an alternative it is also possible to define an optimization problem in which a maximum permissible lap time is predetermined as a boundary condition and an overall drivability index obtained from several individual drivability indexes is optimized.

It is principally possible to perform the above optimization in a manner that is substantially neutral with respect to the driver, which means that the variables that can be influenced by the driver such as steering angle or gas pedal position are assumed in a fitting manner in order to enable a simulation. It is preferable, however to explicitly model the driver's behavior and to save the same to a separate drive model. Such a driver model is adjusted appropriately to the available drivers individually insofar as applications in racing sports are concerned. For series-produced vehicles it is possible to alternatively define different types of drivers and represent them by a simulation model. The relevant aspect in any type of driver model is that the behavior of the driver depends on the behavior of the vehicle. It has also been seen in this area that drivability indexes are especially suitable in order to represent these dependencies and to reflect them in the simulation model. Moreover, it is has been seen as useful and beneficial to define driver evaluation indexes (as in the vehicle itself) which are representative of the behavior and quality of the driver.

Different optimization methods can be used for the optimization step which are suitable of coping with complex optimization tasks as are outlined here. A model-based optimization strategy can principally be used, which is also designated as “full factorial” method. The changeable parameters are varied during the simulation until an optimum has been achieved or one has sufficiently come close to the optimum. No special knowledge of the nature of the system is used for the optimization per se.

As an alternative to this it is possible to use so-called experience-oriented optimization strategies or DOE (design of experiments) strategies. It is tried to accelerate the optimization by taking into account relations following from the knowledge of the behavior of the simulated system. The definition of such optimization strategies is more complex, but faster progress is generally made in the optimization.

In an especially preferred variant of the method in accordance with the invention, the optimization is performed in the course of the simulation, such that starting from an initial configuration of setting parameters a simulation cycle is performed with a plurality of simulation runs in which a predetermined, substantially identical driving cycle is run through while the setting parameters are varied in order to determine the influence of the setting parameters on the target function and the boundary conditions. This is performed in such a way because a large number of setting parameters can be changed, but it is not known from the beginning which influence the individual-setting parameters will have on the target function and the boundary conditions. As a result, the effects of the change of every single setting parameter can be determined ceteris paribus, with interactions and synergy effects between the individual-setting parameters being disregarded.

A first meta model is prepared specially preferably on the basis of the results of the simulation cycle, which meta model reflects the influence of the input parameters on the target function and the boundary conditions. Thereafter, a first optimization step is performed on the basis of the meta model in order to determine a first optimal configuration of setting parameters, whereupon at least one further simulation cycle is performed on the basis of said first optimal configuration of setting parameters in order to produce a further meta model. The individual simulation runs represent a substantial amount of computing work. An optimization only on the basis of such simulation runs causes a prohibitively large amount of computing work in somewhat complex models close to reality. The aforementioned use of a meta model in which the target function and the boundary conditions are represented within the terms of an approximation as explicit functions of the setting parameters allows performing an optimization with a substantially lower amount of computing work. The relevant difference of the actual simulation model to the meta model is that many variables are calculated as integrals of other variables over time in the simulation model and that the relations are non-linear and interdependent. Moreover, many intermediate variables are used in the simulation model which principally are not of interest but are required for illustrating the model.

In contrast to this, the meta models are simple and provide a direct relationship between the setting parameters and the target function and the boundary conditions without containing temporal integrals for example. In a first variant of this method, the meta models are linear models. The optimization is thus simplified in particular, because the setting parameters for a certain desired result can be obtained by inverting a model matrix.

This extreme simplification has a price in the respect that the meta model describes the actual behavior of the system in a satisfactory way only in a sufficiently small environment of the initial configuration. Once one has performed the first optimization step as a result of the first meta model which leads to a first optimal configuration of setting parameters, at least one further simulation cycle is performed in order to generate a further meta model. Errors are thus excluded which arise from the simplifications of the meta model. Generally speaking, the first optimal configuration will thus actually not be optimal in the sense of the actual simulation model, but it will be closer to such an optimum than the initial configuration. A freely chosen precise approximation to an actual optimum can be achieved by repeating the above steps as required.

An improved precision of the meta models can be achieved in such a way that these models are such in which the setting parameters are included partly linearly and partly quadratic in the target function and boundary conditions. The fact is utilized that at least in the absence of boundary conditions an optimum in the target function expresses itself by, disappearing derivations of the target variable according to the independent variables, i.e. the setting parameters, so that a quadratic model reflects the environment of the optimum better than a linear model. The additional work in the calculation caused by the quadratic approach can be reduced when it is limited to setting parameters of which one can assume that they are not determined primarily by boundary conditions.

In the case of an application of the method in accordance with the invention in racing sports, the target function is generally the lap time which the vehicle requires to cover a certain track. Lap time shall generally also be understood as a segment time, which is the driving time for a partial section of a race circuit. Boundary conditions are obtained from the rules and drivability indexes which reflect understeering globally or in a certain curve.

In an application of the method in accordance with the invention in the development of series-produced vehicles it is provided for example that the target function is an overall drivability index which globally describes the drivability of the vehicle. Driving convenience can thus be, optimized in an objectively verifiable manner. The target function can also be a fuel consumption value which states the fuel quantity which the vehicle requires for covering a predetermined circuit, so that the representation of a vehicle with optimal consumption is possible.

Especially reliable results are achieved when the boundary conditions are at least partly drivability indexes which reflect the drivability of the vehicle in partial sections of a simulation run, with all partial sections of the simulation run being covered.

In a first embodiment of the method in accordance with the invention the entire vehicle in real operation is used in the measurements in order to obtain the required measured values. The measured values are obtained from a completely real situation on the road. Such a method is obviously connected with a relatively high amount of work and effort. If there are already data on partial systems, the amount of work can therefore be minimized by so-called “hardware in the loop” methods, in which partial systems are replaced by simulation models. The following constellations are possible:
the vehicle is on a roller-type test stand: aerodynamic effects must be reflected by a simulation model; influencing variables such as wheel suspension, tires and the like cannot be considered directly;
a further simplification of the measurements is obtained when the engine of the vehicle is examined on a highly dynamic test stand; in addition to the variables described above it is also necessary to simulate all variables in connection with the drive train;
a single subsystem such as the engine control device can be examined separately for special examinations; it is necessary to simulate all variables that cannot be influenced directly by the control device.

An especially advantageous embodiment of the method in accordance with the invention is given when after performing the measurements from the real operation of the vehicle changes are defined on the vehicle and the simulation model is prepared on the basis of the amended vehicle. In many cases there are real measured values of a vehicle on a certain track and there is the task of forecasting the expected behavior of a vehicle which has been slightly modified in the meantime. In this way it is possible to consider in the simulation model; changes planned in the vehicle or changes that have already been performed but have not yet been tested on a certain track, and to analyze the effects of such changes. A special advantage is that it is not only possible to forecast the direct changes of the otherwise unchanged vehicle with respect to driving performance, but also to provide in the simulation an optimization of the amended vehicle by a suitable selection offsetting parameters.

By providing a respective computing capacity it is possible that after an initial preparation of the simulation model during the real operation of the vehicle, the simulation of the vehicle occurs continuously in real time by using the simulation model. This may be useful during a race when increasing wear and tear of tires or the like needs to be considered in order to allow planning and evaluating possible changes to the setting parameters during the race. The optimization of the setting of the vehicle can occur continuously in real time in order to make changes to the setting parameters. But even in cases where there is a respective computer on board of a series-produced vehicle, continuous readjustments can be made to the setting parameters in order to take into account aging phenomena and wear and tear. In this connection it is especially advantageous when changes to the setting parameters of the vehicle are performed automatically.

The following variables play a role in the method in accordance with the invention:
Uᵢ Environmental parameters such as condition of the road, air pressure. It concerns external parameters which cannot be influenced, but which are included in the model.
Eᵢ Setting parameters: measurable variables which characterize the vehicle and can be changed (at least principally). Examples: spring characteristics, engine, characteristics, transmission multiplications, vehicle weight, air resistance, and drifting or lifting values of the vehicle.
Sᵢ Simulation parameters: these are variables which do not correspond to any measurable variable and which are required for setting the simulation model. Examples: tire characteristics (if not known), elasticity of the drive train (if not known).
Fᵢ(t) Driver-determined, variables such as steering angle, gas pedal position. These variables are changeable over the course of time and are therefore stated as functions of time. These parameters could also be represented as functions of location via the vehicle speed.
Mᵢ(t) Measured values which characterize the behavior of the vehicle and which can be measured in reality as well as by the simulation model. Examples: longitudinal acceleration, transverse acceleration, engine temperature. The fictitious measured values as calculated by the simulation model can be represented as a function of the environmental parameter, the simulation of the setting parameters; the simulation parameters and the driver-determined variables as well as the other measured values:

Msimᵢ(t)=f(Uᵢ,Eᵢ,Sᵢ,Fᵢ(t),Msimⱼ(t))
DRᵢ Drivability indexes for certain driving maneuvers and/or track sections. The
DRᵢ are calculated on the basis of previously determined empirical data from Mᵢ(t) or Msimᵢ(t).

The invention is now explained in closer detail by reference to the embodiments shown in the drawings, wherein:

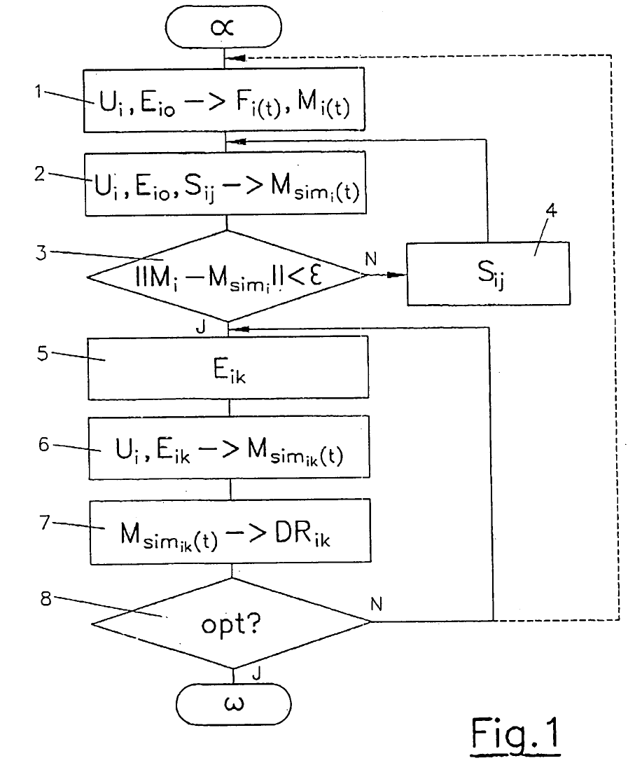

FIG. 1 shows a flow chart for explaining the method in accordance with the invention in a first embodiment;

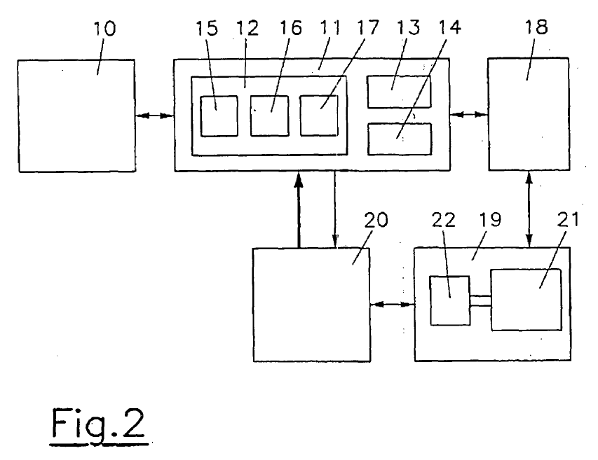

FIG. 2 shows a block diagram showing relevant components in performing the invention;

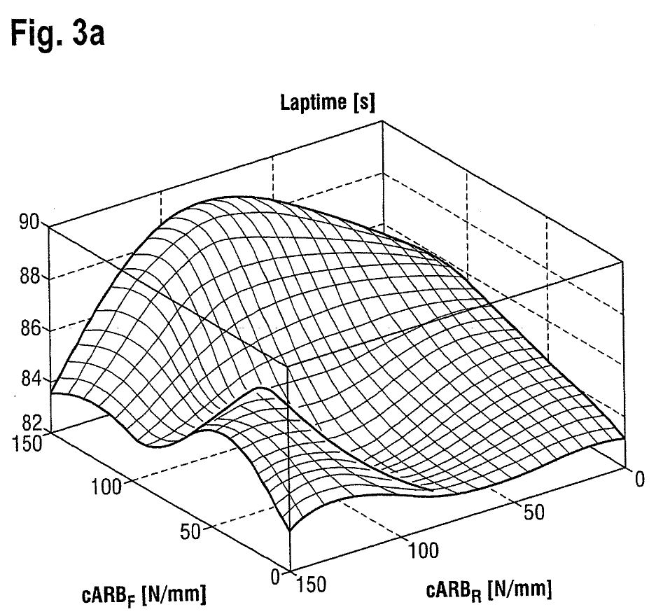

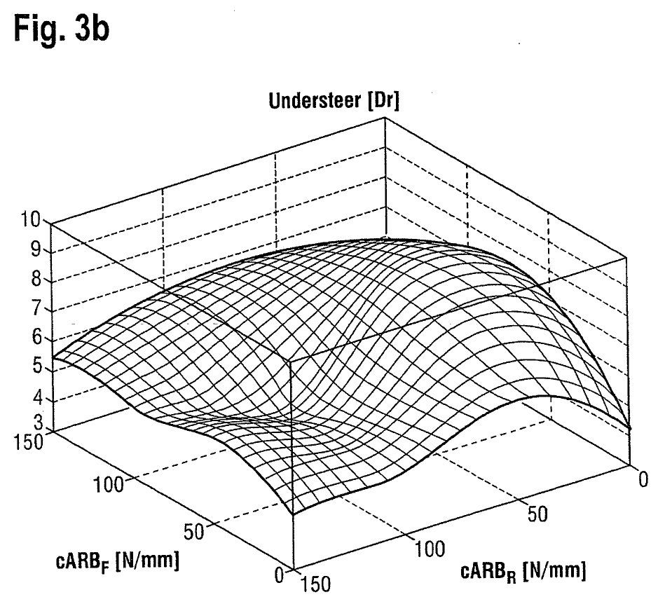

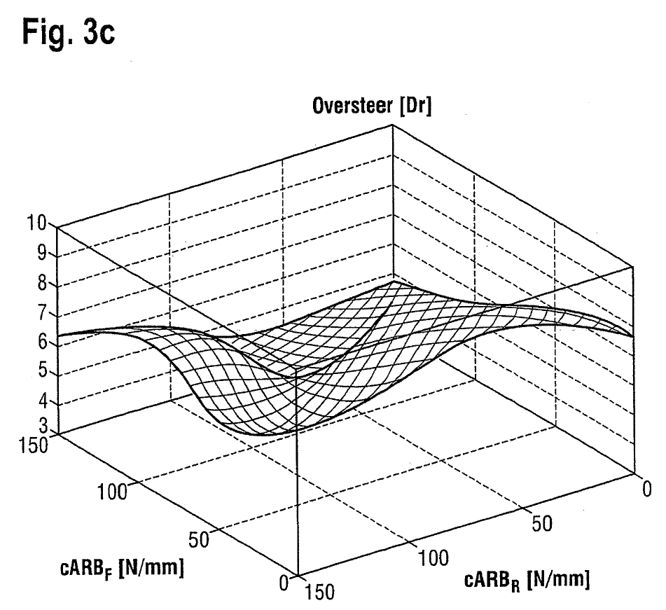

FIGS. 3a, 3b, 3c to FIGS. 9a, 9b, 9c show diagrams which illustrate the method in accordance with the invention on the basis of a simplified example.

The individual steps of the flow chart of FIG. 1 are now explained as follows:
Step 0: Start
Step 1: real round: a vehicle with predetermined setting parameters Eᵢₒ is operated: on a real racing track or a test stand, with Fᵢ(t) and Mᵢ(t) being recorded. In addition, the environmental parameters Uᵢ are monitored. As already explained above, this real lap can also be driven with the predecessor model of the vehicle.
Step 2: virtual round; a lap is simulated on the computer with the help of the simulation model. Uᵢ and Eᵢₒ are entered into the simulation model as predetermined; the calculation is further based on the simulation parameters Sᵢⱼ, with, the index: j designating the respective version of the simulation parameter Sᵢ after j simulated rounds. This means that it is started with an initial set of simulation parameters Sᵢₒ which is subsequently improved.
Variant 1: The driver-determined variables Fₗ(t) are accepted substantially from the real lap.
Variant 2: The driver model is part of the simulation model (or an additional simulation model, which is equivalent), and the driver-determined variables Fₗ(t) are co-simulated as Fsimᵢ(t)(=calculated).
The result of the simulation is a set of virtual measured values Msimₗⱼ(t) (and optionally Fsimₗⱼ(t)) for the simulated round j.
Step 3: Query: is the precision of the simulation model sufficient? This is principally determined from the difference between Mᵢ(t) and Msimᵢⱼ(t) (and optionally between Fᵢ(t) and Fsimᵢⱼ(t)). There generally are evaluation functions because mostly number of measured values will be more critical than others and therefore there are different tolerances. In addition, the magnitude of DR is: used for calculating the precision.
When NO: Step 4: Generation of a new set of simulation parameters Sᵢⱼ and return to step 2. The calculation of the new Sₗⱼ can certainly occur purely mathematically (optimization task without knowledge of the inner system relations) or it is possible to use information on the real relations. Combinations of both are also possible.
When YES: Step 5.
Step 5: Virtual changes of the vehicle setting: the initial setting parameters Eᵢₒ are changed to Elk, with k being a counter for the respective optimization step.
Step 6: Virtual test round: by using the new setting parameter Eᵢₖ. As in step 2, simulated measured values are calculated which are designated here as Msimᵢₖ(t), because they are present after k optimization steps.
Variant 1: The driver-determined variable Fₗ(t) are accepted unchanged from the real lap.
Variant 2: The driver model is a part of the simulation model (or an additional simulation model, which is equivalent) and the driver-determined variables are co-simulated. The special advantage in this case: the behavior of the driver can be forecast in an especially simple manner close to reality on the basis of DRᵢₖ, which are drivability indexes (next step).
Step 7: Drivability calculation: calculation of DRᵢₖ, which are drivability indexes after k optimization steps.
Step 8: Query: Evaluation of the optimization progress: Has sufficient progress been achieved?
When NO: Return to step 5.
If YES: End of procedure or optionally return to step 1.

The vehicle optimization (steps 5 to 8) represents a non-linear optimization task with a target function and several boundary conditions.

The block diagram of FIG. 2 shows the relevantly involved components in a schematic representation.

A real vehicle 10 is operated on a predetermined track. Based on the measured values, a simulation model 11 is parameterized which can be subdivided internally into a vehicle model 12, a driver model 13 and a track model 14. The vehicle model 12 on its part can be subdivided into sub-models such as a driving dynamics model 15, an aerodynamic model 16 and a tire model 17 and, if required, further sub-models not illustrated here.

Reference numeral 18 designates a really used traction control which receives the input variables from simulation model 11 which are not really available on the test stand, e.g. the vehicle speed. Traction control 18 controls a highly dynamic test stand 19, which on its part returns the required real data such as engine speed to traction control. The test stand 19 consists of a real engine 21 which is coupled with an electric brake 22.

Reference numeral 20 designates the electronic control system for the test stand 19, which on its part exchanges data with the simulation model 11. With the data obtained with the simulation model 11 it is possible to change and optimize the setting parameters of the vehicle 10.

As a result of the closed loop between simulation model 11, traction control 18, test stand 19 and electronic control system 20, such a configuration is also known as a closed-loop model. Such a configuration can be used on the one hand as a simulation model not completely realized in software in order to simulate the real vehicle 10 in the inventive manner. It can also be reflected completely in the software by application of the method in accordance with the invention in order to avoid or accelerate test stand examinations.

In the case of a complete software simulation of the vehicle 10, it is necessary to provide a sub-model reflecting the engine as a part of the simulation model 11.

An optimization process is explained below in closer detail by using a linear meta model. Since a validated simulation model is present in step 3 of FIG. 1, so many vectors are produced in step 5 instead of a single vector of setting parameters Eᵢₖ as setting parameters are provided, with each of this vectors Eᵢₖ differing from vector Eᵢₒ in such a way that a single setting parameter is changed by a predetermined value.

In step 6, a virtual test lap is performed with each of the setting parameter vectors Eᵢₖ and the values Msimₗₖ(t) and subsequently the DRₗₖ are obtained. This allows influencing the individual setting parameters in an isolated manner.

When the setting parameter vectors E are composed for example of 150 individual setting values such as the wing setting angle or spring constant or damping values in the individual wheel suspensions, and when the resulting vector Msim is composed of 300 individual values which form target values and boundary conditions such as lap time, section times, fuel consumption, individual drivability indexes such as understeering in certain curves and overall drivability indexes such as bucking, global understeering or a general drivability index, a linear representation of the following form can be stated:

V·E=Msim

In this case, V is a matrix of 300 lines and 150 columns representative of the aforementioned meta model. A desired result vector Msim can be obtained in a simple manner by inverting this matrix:

E=V⁻¹Msim

It is understood that as a result of the redundancy of the equation system it is not possible to reach Msim precisely with each value. This is irrelevant however because most values of Msim concern boundary conditions which are present in the form of inequations.

With the help of the above equation, a setting parameter vector E can easily be found which results in a result vector Msim, which on its parts is permissible, i.e. it fulfils all boundary conditions, but which on the other hand is optimal, i.e. it maximizes or minimizes the target function.

Said first optimal setting parameter vector E which consists of the values Eᵢ₁ is now used for a further simulation cycle in which the individual Eᵢ₁ are varied successively again. This sequence is repeated until a sufficient precision has been achieved.

The invention is explained in closer detail on the basis of a simplified example in FIGS. 3a to 9c. It is assumed that only two setting parameters are changeable, namely cARB_{F} and cARB_{R}, which are the spring stiffness of the front or rear stabilizer. The lap time is to be optimized, and two drivability indexes of understeering and oversteering are to be held as boundary conditions above certain predetermined limit values. These drivability indexes of understeering and oversteering determine the understeering and, oversteering behavior of the vehicle in certain driving situations.

The diagram of FIG. 3a shows the lap time as a function of cARB_{F} and cARB_{R}. The diagrams of FIGS. 3b and 3c show the drivability indexes understeering and oversteering as functions of cARB_{F} and cARB_{R}. Notice must be taken that these functions are not known in advance and finally will also never be fully known in application of the method in accordance with the invention.

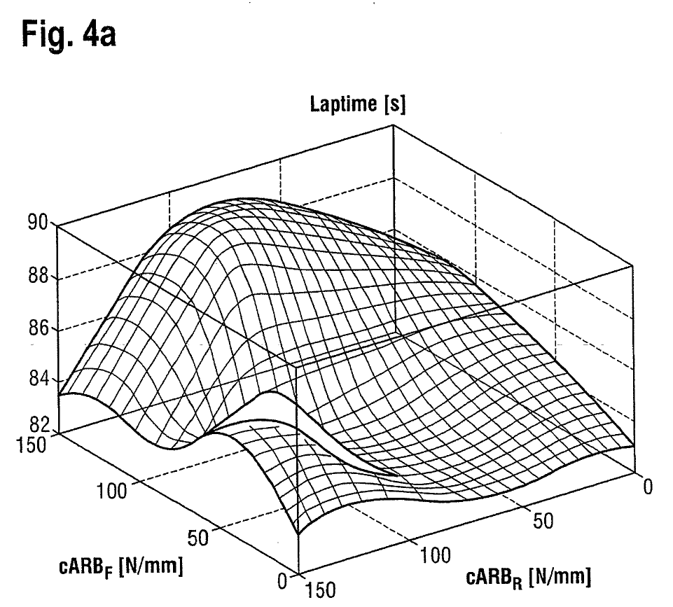

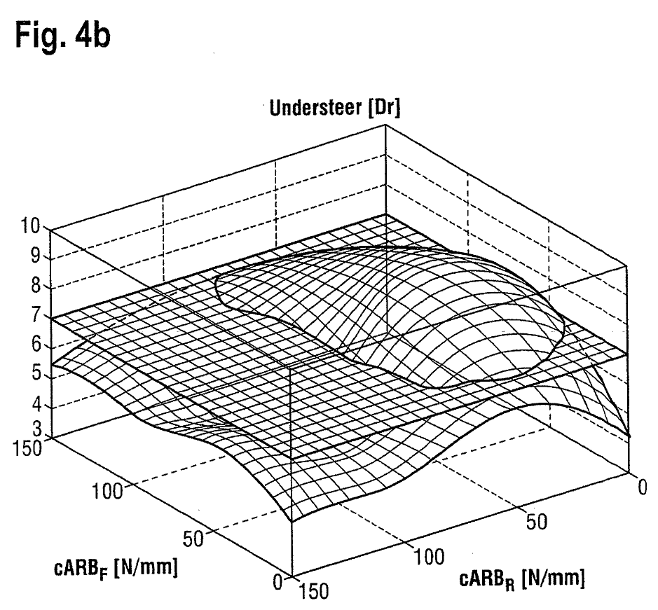

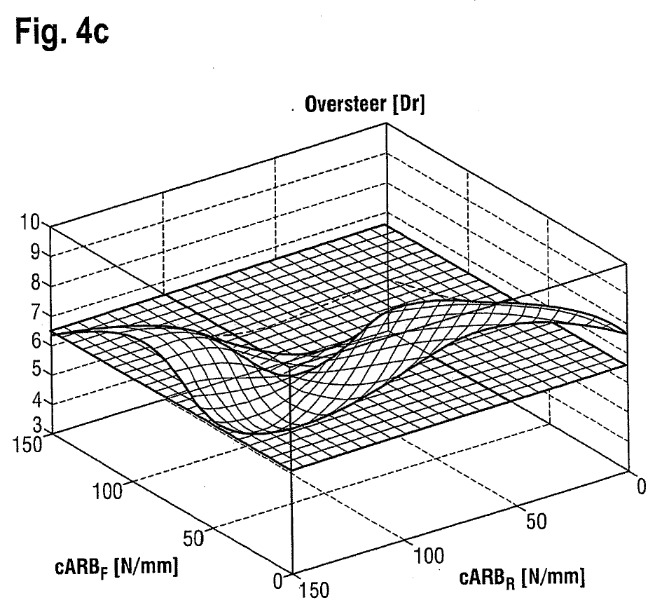

FIGS. 4b and 4c again show the drivability indexes understeering and oversteering as functions of cARB_{F} and cARB_{R}. The limit values of understeering a 7 and oversteering≧6.5 are entered as horizontal planes. The value pairs for cARB_{F} and cARB_{R} in which the above conditions are fulfilled represent the permissible range for the optimization. The diagram of FIG. 4a is unchanged for the target function lap time.

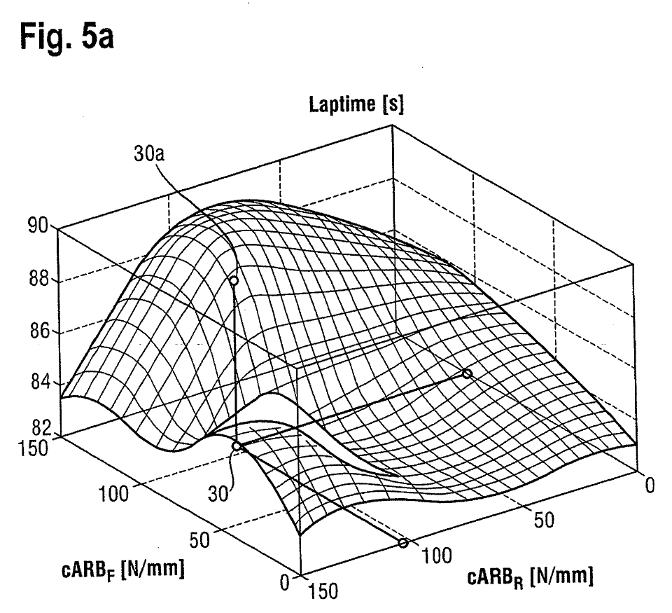

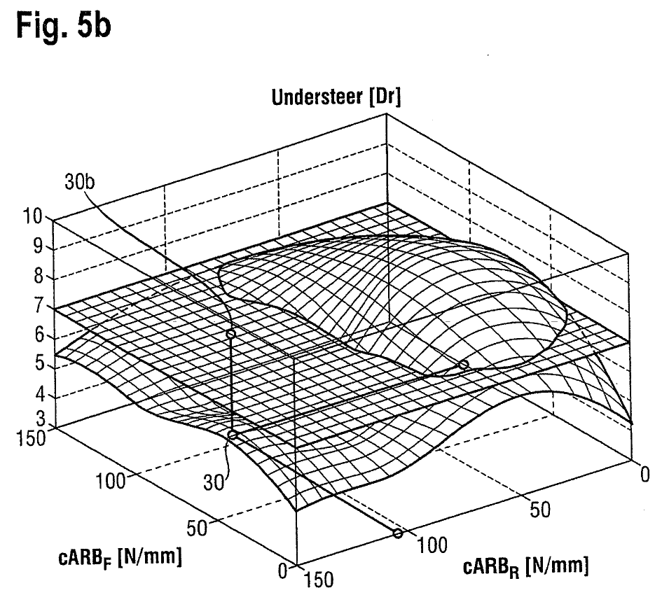

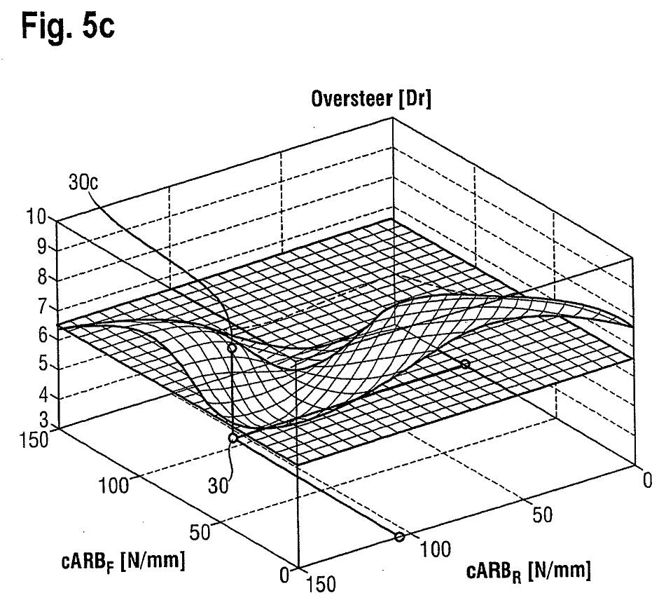

FIGS. 5a, 5b and 5.c show a starting value 30 of cARB_{F} and cARB_{R} of 105 N/mm each and the resulting fictitious measured values of lap time, understeering and oversteering, which are designated with 30a, 30b and 30c. These measured values can be obtained in, principle-by a single simulated lap. The illustrations show that these setting parameters are neither optimal, nor permissible. The impermissibility is shown in FIG. 5c which shows that oversteering is considerably smaller than the limit value of 6.5. The non-optimal character is shown in FIG. 5a because there are obviously value pairs of cARB_{F} and cARB_{R} which lead to lower lap times.

In a first phase of the optimization process it is necessary to bring about permissibility. Therefore as many laps are simulated as there are setting parameters in order to determine the local gradients of the functions of understeering and oversteering. As a result, it is possible to prepare a meta model in the sense as described above which allows stating the required setting parameters for the desired values for the target function and the boundary conditions. This meta model is valid within the environment of the starting point within which the linearization represents an acceptable simplification.

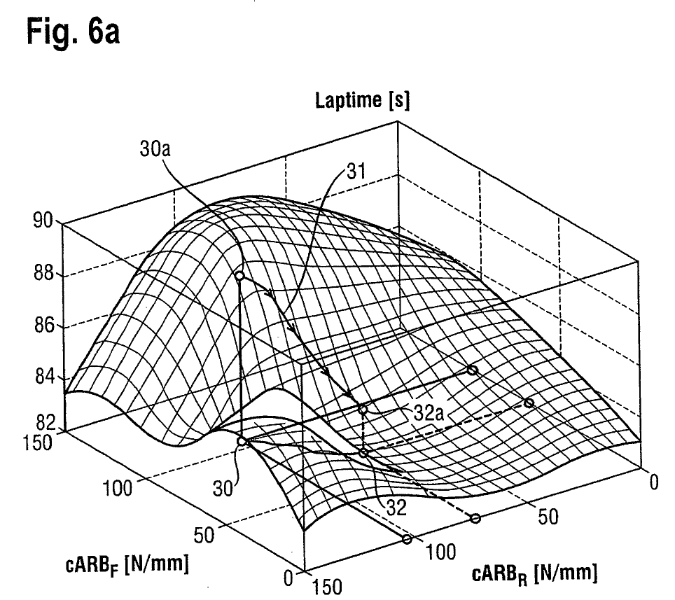

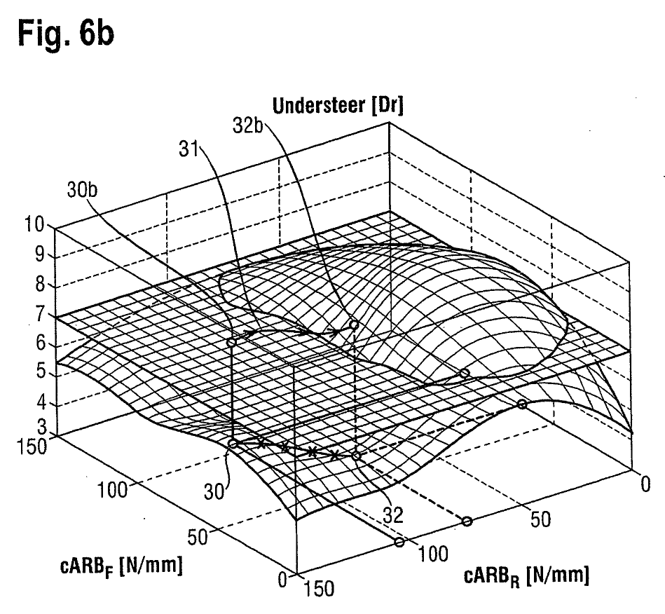

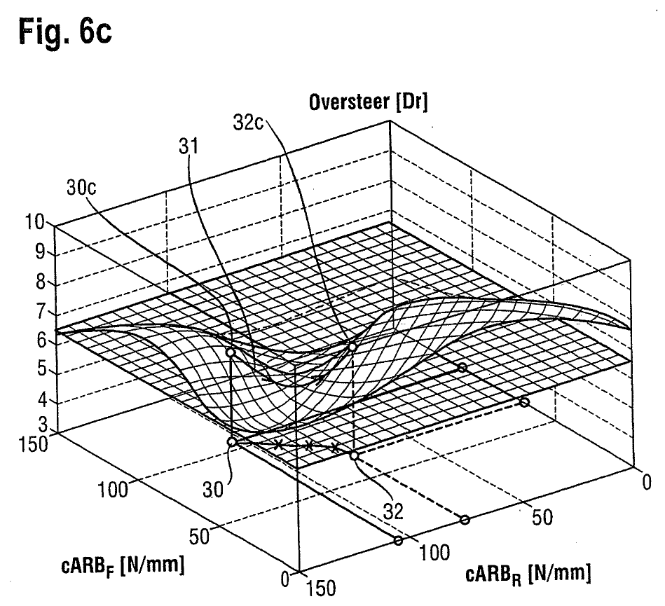

Depending on the difficulty of the problem, it is now necessary to carry out one or several steps, which means new meta models, to find a path to a value pair of cARB_{F} and cARB_{R} which fulfills the given boundary conditions. Such a path 31 is shown in FIGS. 6a, 6b and 6c, which path leads to a point 32 or to the points 32a, 32b and 32c, which is defined by cARB_{F}=65. N/mm and cARB_{R}=75 N/mm and which lies within the permissible range. This setting is still not optimal however, as is shown in FIG. 6a.

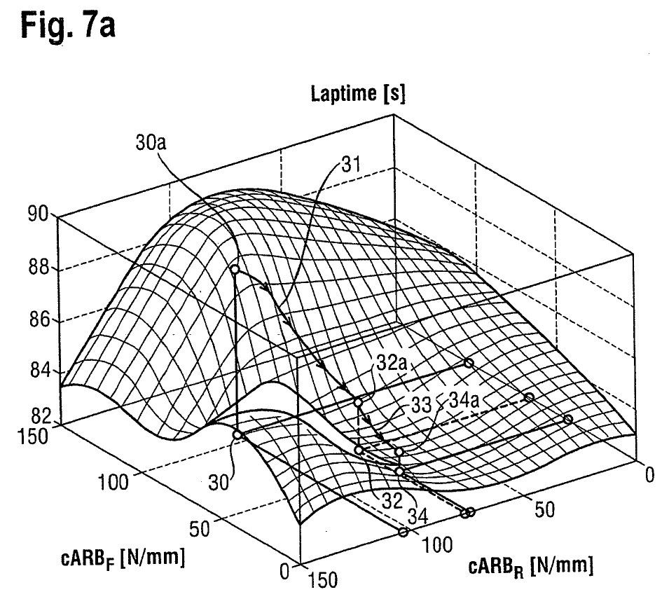

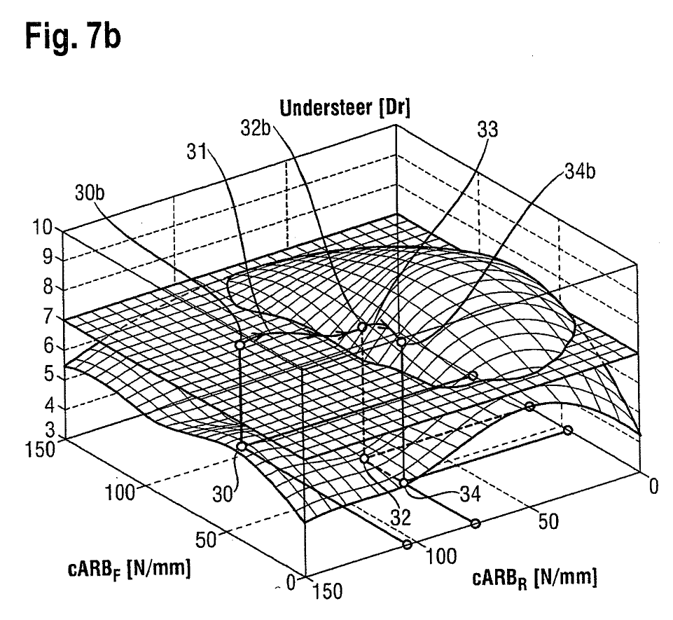

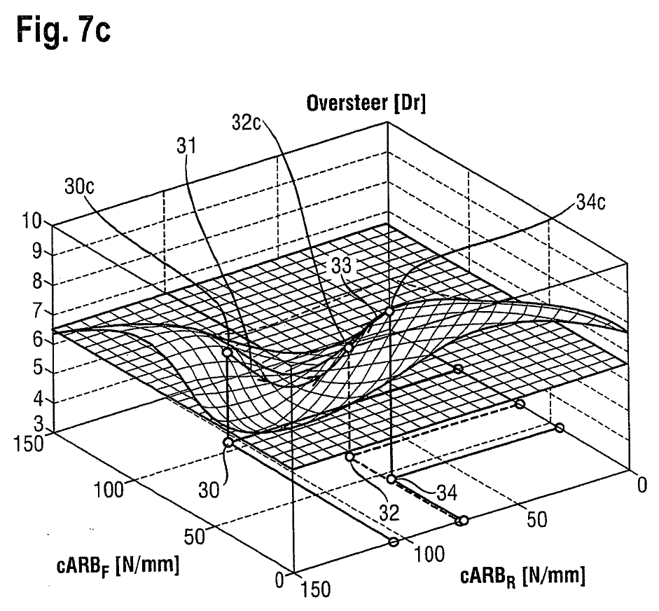

Based on this permissible but not optimal point 32, an optimization of the target function lap time is carried out in a second phase of the optimization method. This occurs in such a path that a linearization about the respectively achieved intermediate point is performed at least one, but mostly several times, and a locally optimal path is determined. It needs to be considered at all times however that the permissible range, is, not left. In this way, one reaches the points 34 or 34a, 34b and 34c via path 33 in FIGS. 7a, 7b and 7c, i.e. to the optimal result of cARB_{F}=19 N/mm and cARB_{R}=69 N/mm, which results in the following fictitious measured values:
Lap time=83.1 s.
Understeering=9.36
Oversteering=7.21.

Notice must be taken that the above concept of a two-phase optimization can also be altered. It is possible for example to seek in a first phase an optimal, but impermissible point and to produce reliability in a second phase. It is also possible to follow a path of non-optimal impermissible points according to different concepts.

The optimization method is also not limited to linear meta models however. Although the use of quadratic approaches increases the amount of computing per step, it reduces the number of required steps.

A number of setting parameters may concern non-scalar variables such as engine characteristic maps. Such maps cannot be used directly in the above optimization concept. An inclusion in the optimization in accordance with the invention can occur in such a way that at first a variable derived from the engine characteristic map such as a torque demand is modeled and is used in the optimization and thereafter the characteristic map which fits at the respective time is calculated in a further step and is chosen or set in the next simulation or during the next test run.

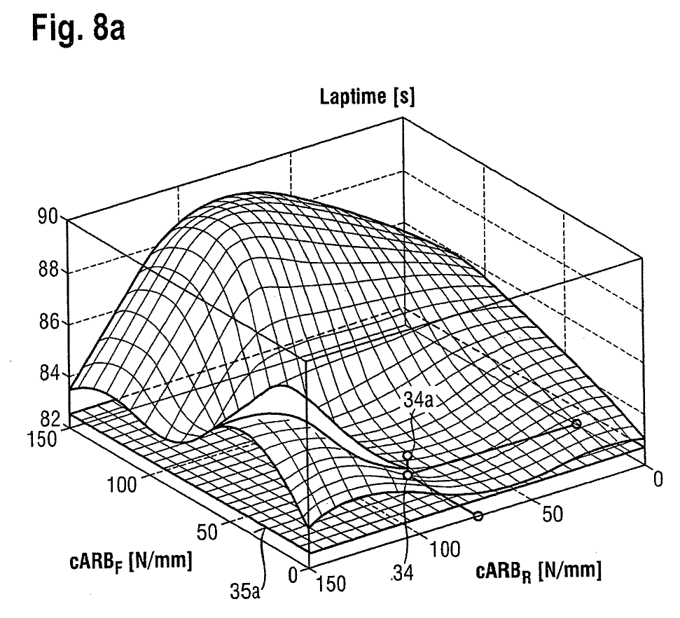

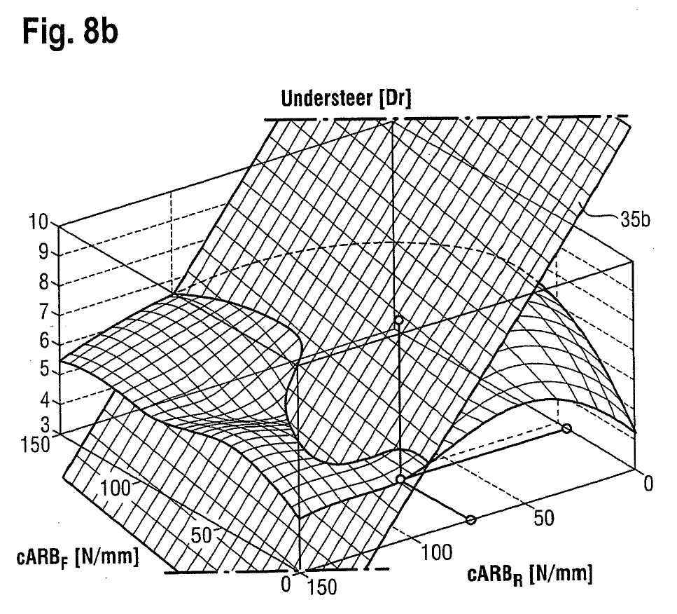

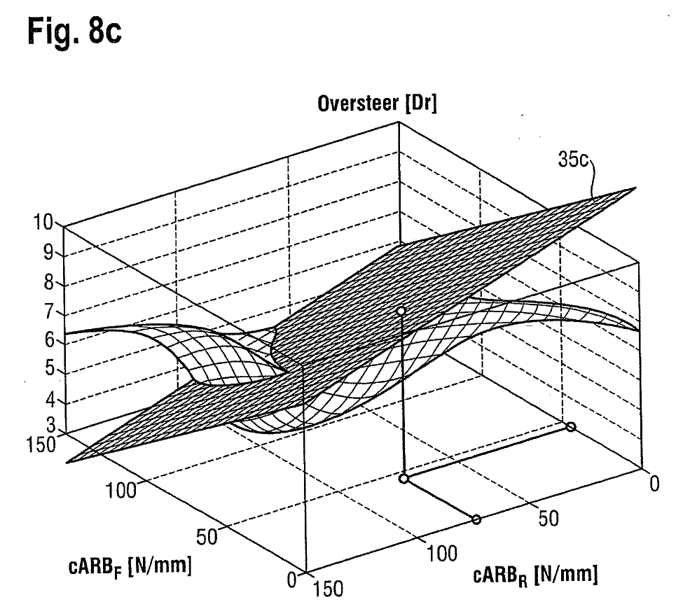

The diagrams of FIGS. 8a, 8b and 8c now show that the concept of linearization can be used advantageously for evaluation and interpretation of the results. By performing a linearization again in the optimum, the sensibility of the achieved result to changes of the setting parameters can be assessed. The respective planes 35a, 35b and 35c have been entered in FIGS. 8a, 8b and 8c, which planes represent the meta model in the optimal point. Since the optimum lines within the permissible range, the plane 35a of the target function of FIG. 8a is horizontal, as expected. The gradients can be expressed in the following way in an algebraic manner:

| | cARB_{F} | cARB_{R} |
|---|---|---|
| Δ Lap time | 0.0000 | 0.0000 |
| Δ Oversteering | 0.0621 | −0.0403 |
| Δ Understeering | −0.1216 | 0.0254 |

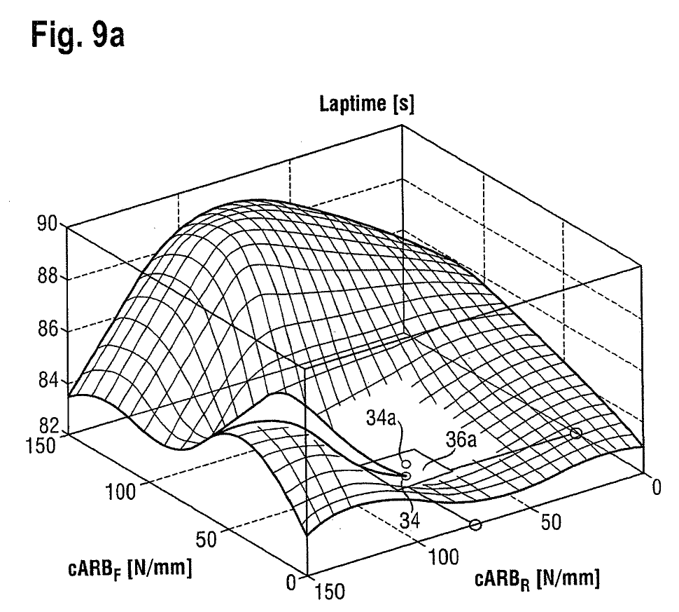

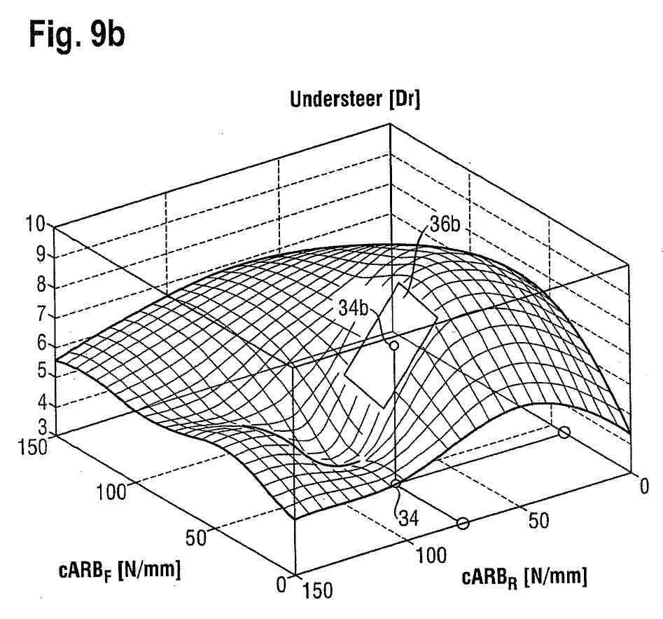

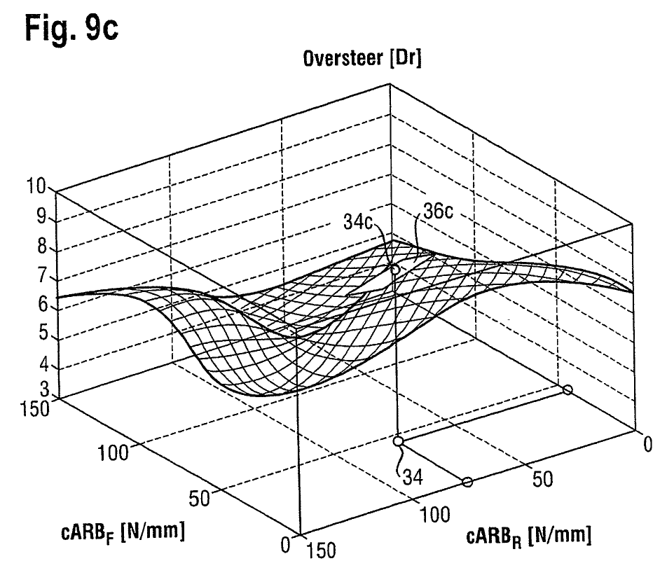

It is also possible to state a range in which the linearized meta model is applicable with predetermined precision. Such ranges 36a, 36b and 36c are shown in FIGS. 9a, 9b and 9c. For the purpose of determining these ranges 36a, 36b and 36c it is necessary to carry out an observation of second order by taking into account the required precision.

The optimization method as represented here does not require as already explained above any complete knowledge of the complex non-linear functions which state the fictitious measured values depending on the setting parameters and which can only be obtained by approximation by performing simulation runs. In a simplified model with two setting parameters it would be possible to consider an overall detection, but in a real model with over one hundred setting parameters this is virtually impossible because the amount of computing work would rise exponentially. The method in accordance with the invention offers a practicable solution.

The present invention allows accelerating and qualitatively improving the vehicle tuning by the application of simulation methods.

1-23. (canceled)

24. A method for optimizing a vehicle and engine for driving the vehicle, comprising the following steps:
performing measurements during real operation of the vehicle on the road or on a roller-type test stand, or of the engine on an engine test stand;
parameterizing a simulation model representative of the vehicle or engine so as to be able to arithmetically make a prediction on measured values obtained by means of said measurements;
simulating the vehicle by using the simulation model, and calculating at least one drivability index which is obtained from several measured values based on an empirically determined function and indicates the drivability of a vehicle in a specific driving mode;
optimizing vehicle settings during said simulation, with at least one drivability index being entered into a target function or boundary conditions of the optimization, wherein the optimization is carried out in the course of the simulation, such that starting from an initial configuration of setting parameters, a simulation cycle is performed with a plurality of simulation runs in which a predetermined, substantially identical driving cycle is accomplished while the setting parameters are varied in order to determine an influence of the setting parameters on the target function and the boundary conditions.

25. A method of claim 24, wherein a driver model is provided which models driver behavior and calculates variables influenced by the driver depending on the driving state.

26. A method of claim 25, wherein at least one drivability index is included as an input variable in the driver model.

27. A method of claim 25, wherein the driver model is parameterized on the basis of at least one driver evaluation index which is obtained on the basis of an empirically determined function from several measured values and which evaluates the driving behavior of a respective driver in a respective driving state.

28. A method of claim 24, wherein at least one drivability index is used in the parameterization of the simulation model, which drivability index is determined both from the measurements from real operation as well as from the simulation model.

29. A method of claim 24, wherein the measurements of real operation are performed under partial use of simulation models, with individual hardware components being subjected to real operation, whereas other hardware components are replaced by simulation models.

30. A method of claim 24, wherein changes on the vehicle are defined after performing the measurements from real operation of the vehicle and the simulation model is prepared thereafter.

31. A method of claim 24, wherein a first model is prepared on the basis of the results of the simulation cycle, which first model reflects the influence of the setting parameters on the target function and the boundary conditions, thereafter a first optimization step is performed on the basis of the first model in order to determine a first optimal configuration of setting parameters, whereupon starting from this first optimal configuration of setting parameters at least one further simulation cycle is performed in order to prepare a second model.

32. A method of claim 31, wherein the first and second models are linear models.

33. A method of claim 31, wherein the first and second models are models in which the setting parameters enter the target function and the boundary conditions in a partly linear manner and in a partly quadratic manner.

34. A method of claim 31, wherein the first and second models are brought algebraically to a representation which is explicit with respect to the setting parameters.

35. A method of claim 24, wherein the target function is a lap time which the vehicle requires for covering a predetermined track or section of a track.

36. A method of claim 24, wherein the target function is an overall drivability index which globally describes the driving behavior of the vehicle.

37. A method of claim 24, wherein the target function is a fuel consumption value which states the fuel quantity which the vehicle requires for covering a predetermined track.

38. A method of claim 24, wherein a model-based optimization strategy is used for the parameterization of the simulation model.

39. A method of claim 24, wherein an experience-oriented optimization strategy is used for the parameterization of the simulation model.

40. A method of claim 24, wherein a model-based optimization strategy is used for the optimization of the setting of the vehicle.

41. A method of claim 24, wherein an experience-oriented optimization strategy is used for the optimization of the setting of the vehicle.

42. A method of claim 24, wherein after an initial preparation of a simulation model during the real operation of the vehicle, the parameterization of a simulation model of the vehicle occurs by using the simulation model continuously in real time.

43. A method of claim 42, wherein the optimization of the setting of the vehicle is performed continuously in real time and changes are made to the setting parameters.

44. A method of claim 24, wherein changes to the setting parameters of the vehicle are made automatically.
